(19) United States
(12) Patent Application Publication
(10) Pub. No.: US 2012/0040584 A1
(43) Pub. Date: Feb. 16, 2012

(54) METHOD FOR PRODUCING PLASMA DISPLAY PANEL

(76) Inventors: Eiji Takeda, Osaka (JP); Takuji Tsujita, Osaka (JP); Masashi Gotou, Osaka (JP)

(21) Appl. No.: 13/266,201

(22) PCT Filed: Mar. 16, 2011
(86) PCT No.: PCT/JP2011/001525

§ 371 Date: Oct. 25, 2011

(30) Foreign Application Priority Data
Mar. 26, 2010 (JP) 2010-071978

(51) Int. Cl. H01J 9/26

(52) U.S. Cl. 445/25

(57) ABSTRACT

A method for producing a plasma display panel including a base layer containing a metal oxide, and aggregated particles dispersed on the base layer includes the following process. The front plate having a protective layer is fired in an atmosphere containing at least one selected from a group consisting of a nitrogen gas, a mixture gas of nitrogen and oxygen, and a rare gas, and a water molecule. Then, a film of a water molecule or hydroxide is formed on a surface of the protective layer at a lowered temperature in the above atmosphere. Then, the front plate having the film, and the rear plate are oppositely arranged. Then, the film is removed from the protective layer, and the water molecule is exhausted from the discharge space by heating the oppositely arranged front plate and rear plate. Then, the front plate having no film and the rear plate are sealed.

### TECHNICAL FIELD

A technique disclosed here relates to a method for producing a plasma display panel used in a display device and the like.

### BACKGROUND ART

A plasma display panel (hereinafter, referred to as the PDP) is composed of a front plate and a rear plate. The front plate is composed of a glass substrate, a display electrode formed on one main surface of the glass substrate, a dielectric layer to cover the display electrode and serve as a capacitor, and a protective layer formed on the dielectric layer and made of a magnesium oxide (MgO). Meanwhile, the rear plate is composed of a glass substrate, a data electrode formed on one main surface of the glass substrate, an base dielectric layer to cover the data electrode, a barrier rib formed on the base dielectric layer, and phosphor layers formed between the barrier ribs and emitting red, green, and blue light, respectively.

The front plate and the rear plate are hermetically sealed with their electrode forming surfaces opposed to each other. A discharge gas such as neon (Ne) and xenon (Xe) is sealed in a discharge space sectioned by the barrier rib. The discharge gas causes discharge by a video signal voltage selectively applied to the display electrode. Ultraviolet rays generated by the discharge excite each phosphor layer. The excited phosphor layer emits red, green, or blue light. The PDP provides a color image display (refer to PTL 1) as described above.

The protective layer mainly has four functions. A first function is to protect the dielectric layer from ion bombardment caused by the discharge. A second function is to emit initial electrons to generate data discharge. A third function is to retain electric charges to generate the discharge. A fourth function is to emit secondary electrons at the time of sustain discharge. When the dielectric layer is protected from the ion bombardment, a discharge voltage is prevented from rising. When the initial electron emission number is increased, a data discharge error causing flickering in an image is reduced. When charge retention performance is improved, an applied voltage is reduced. When the secondary electron emission number is increased, a sustain discharge voltage is reduced. In order to increase the initial electron emission number, an attempt to add silicon (Si) or aluminum (Al) to MgO of the protective layer is made (refer to PTLs 1, 2, 3, 4, and 5, for example).

### CITATION LIST

### Patent Literature

[PTL 1] Unexamined Japanese Patent Publication No. 2002-260535
[PTL 2] Unexamined Japanese Patent Publication No. 11-339665
[PTL 3] Unexamined Japanese Patent Publication No. 2006-59779
[PTL 4] Unexamined Japanese Patent Publication No. 8-236028
[PTL 5] Unexamined Japanese Patent Publication No. 10-334809

### SUMMARY OF THE INVENTION

A method for producing a PDP is provided, and the PDP includes a rear plate, and a front plate sealed with a discharge space provided with the rear plate. The front plate has a dielectric layer, and a protective layer to cover the dielectric layer. The protective layer includes a base layer formed on the dielectric layer. Aggregated particles composed of aggregated crystal particles made of a magnesium oxide are dispersed all over the base layer. The base layer contains at least a first metal oxide and a second metal oxide. The base layer has at least one peak through an X-ray diffraction analysis. The peak of the base layer exists between a first peak of the first metal oxide through an X-ray diffraction analysis, and a second peak of the second metal oxide through an X-ray diffraction analysis. The first peak and the second peak show the same surface orientation as a surface orientation shown by the peak. The first metal oxide and the second metal oxide are composed of two kinds of oxides selected from a group consisting of a magnesium oxide, a calcium oxide, a strontium oxide, and a barium oxide.

The method for producing the PDP includes following processes. The front plate having the protective layer is fired at a temperature in a range of 350° C. to 500° C. in an atmosphere containing a water molecule and at least one gas selected from a group consisting of a nitrogen gas, a mixture gas of nitrogen and oxygen, and a rear gas. Then, a film of a water molecule or hydroxide is formed on a surface of the protective layer by lowering a temperature to 200° C. or less in the above atmosphere. Then, the front plate having the film and the rear plate are oppositely arranged. Then, the film is removed from the protective layer and the water molecule is exhausted from the discharge space by heating the oppositely arranged front plate and the rear plate. Then, the front plate from which the film has been removed and the rear plate are sealed together.

### BRIEF DESCRIPTION OF DRAWINGS

FIG. 1 is a perspective view showing a structure of a PDP according to an exemplary embodiment.

FIG. 2 is a cross-sectional view showing a configuration of a front plate according to the embodiment.

FIG. 3 is a view showing steps for producing the PDP according to the embodiment.

FIG. 4 is a view showing a result of an X-ray diffraction analysis of a base film according to the embodiment.

FIG. 5 is a view showing a result of an X-ray diffraction analysis of a base film having another configuration according to the embodiment.

FIG. 6 is an enlarged view of aggregated particles according to the embodiment.

FIG. 7 is a view showing a relationship between a discharge delay and a calcium (Ca) concentration in a protective layer in the PDP according to the embodiment.

FIG. 8 is a view showing a relationship between electron emission performance and a Vscn lighting voltage in the above PDP.

FIG. 9 is a view showing a relationship between an average particle diameter of an aggregated particle and electron emission performance according to the embodiment.

FIG. 10 is a view showing a relationship between the average particle diameter of the aggregated particle and a barrier rib fracture probability according to the embodiment.

FIG. 11 is a view showing steps for forming the protective layer according to the embodiment.

FIG. 12 is a view showing a state after a film has been formed according to the embodiment.

FIG. 13 is a view showing a result of a TDS according to the embodiment.

### DESCRIPTION OF EMBODIMENTS

### 1. Basic Structure of PDP

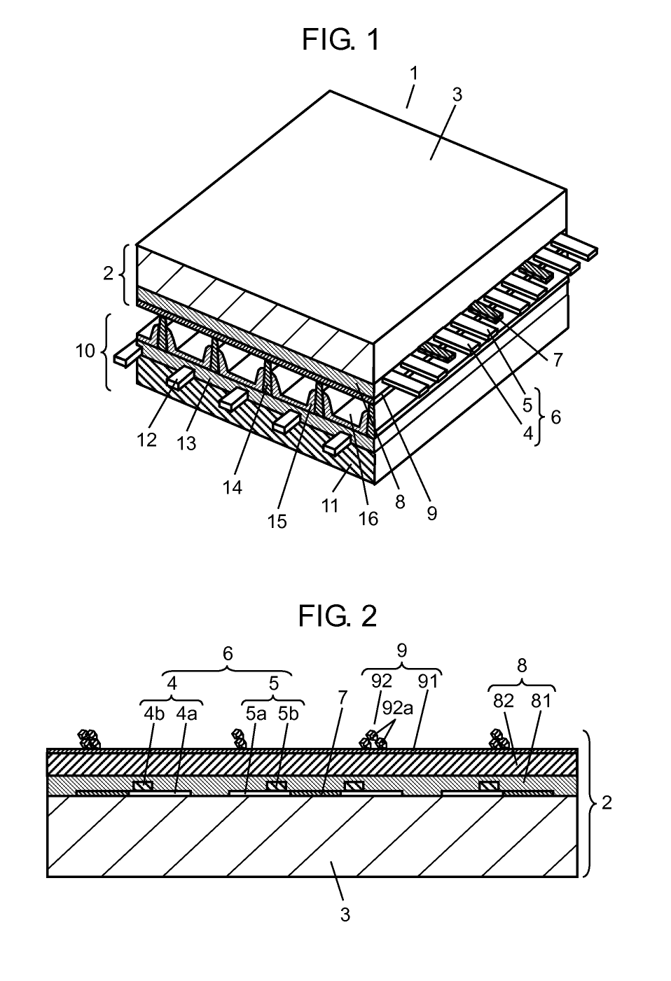

A basic structure of a PDP corresponds to that of a general alternating current (AC) surface discharge type PDP. As shown in FIG. 1, PDP 1 is provided in such a manner that front plate 2 including front glass substrate 3, and rear plate 10 including rear glass substrate 11 are arranged so as to be opposed to each other. Peripheral parts of front plate 2 and rear plate 10 are hermetically sealed with a sealing material composed of a glass frit. A discharge gas such as Ne or Xe is sealed at a pressure of 53 kPa to 80 kPa in discharge space 16 provided in sealed PDP 1.

Strip-shaped display electrodes 6 each composed of a pair of scan electrode 4 and sustain electrode 5, and black stripes 7 are arranged on front glass substrate 3 so as to be parallel to each other. Dielectric layer 8 serving as a capacitor is formed on front glass substrate 3 so as to cover display electrodes 6 and black stripes 7. In addition, protective layer 9 composed of MgO is formed on a surface of dielectric layer 8. In addition, as shown in FIG. 2, protective layer 9 according to this embodiment includes base film 91 serving as a base layer laminated on dielectric layer 8, and aggregated particles 92 attached on base film 91.

Each of scan electrode 4 and sustain electrode 5 is constituted in such a manner that a bus electrode containing Ag is laminated on a transparent electrode composed of a conductive metal oxide such as an indium tin oxide (ITO), a tin dioxide (SnO₂), or a zinc oxide (ZnO).

Data electrodes 12 each composed of a conductive material mainly containing silver (Ag) are arranged parallel to each other on rear glass substrate 11, in a direction perpendicular to display electrodes 6. Data electrode 12 is covered with base dielectric layer 13. Furthermore, barrier rib 14 having a predetermined height is formed on base dielectric layer 13 to section discharge space 16, between data electrodes 12. Phosphor layer 15 emitting red light, phosphor layer 15 emitting green light, and phosphor layer 15 emitting blue light under ultraviolet rays are sequentially applied and formed with respect to each data electrode 12, on base dielectric layer 13 and on a side surface of barrier rib 14. A discharge cell is formed at an intersecting position of display electrode 6 and data electrode 12. The discharge cell having red, green, and blue phosphor layers 15 arranged in a direction along display electrode 6 serves as a pixel for a color display.

In addition, according to this embodiment, the discharge gas sealed in discharge space 16 contains 10 vol. % to 30 vol. % of Xe.

### 2. Method for Producing PDP

Next, a method for producing PDP 1 will be described.

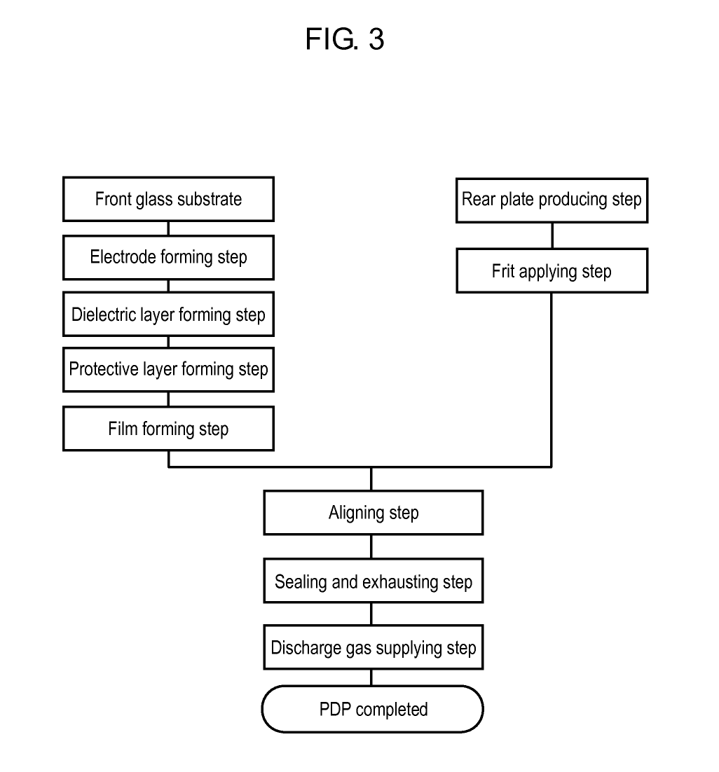

First, a method for producing front plate 2 will be described. As shown in FIG. 3, in an electrode forming step, scan electrode 4, sustain electrode 5, and black stripe 7 are formed on front glass substrate 3 by photolithography. Scan electrode 4 and sustain electrode 5 have bus electrodes 4b and 5b containing Ag, respectively to ensure conductivity. In addition, scan electrode 4 and sustain electrode 5 have transparent electrodes 4a and 5a, respectively. Bus electrode 4b is laminated on transparent electrode 4a. Bus electrode 5b is laminated on transparent electrode 5a.

Transparent electrodes 4a and 5a are each made of ITO to ensure transparency and electric conductivity. First, an ITO thin film is formed on front glass substrate 3 by sputtering. Then, transparent electrodes 4a and 5a are formed into predetermined patterns by lithography.

As materials of bus electrodes 4b and 5b, a white paste containing Ag, a glass frit to bind Ag, a photosensitive resin, and a solvent is used. First, the white paste is applied onto front glass substrate 3 by screen printing. Then, the solvent is removed from the white paste in a furnace. Then, the white paste is exposed with a photomask having a predetermined pattern put thereon.

Then, the white paste is developed and a bus electrode pattern is formed. Finally, the bus electrode pattern is fired at a predetermined temperature in the furnace. That is, the photosensitive resin is removed from the bus electrode pattern. In addition, the glass frit melts in the bus electrode pattern. The molten glass frit becomes glass after fired. Through the above steps, bus electrodes 4b and 5b are formed.

Black stripe 7 is made of a material containing a black pigment.

Then, in a dielectric layer forming step, dielectric layer 8 is formed. As a material of dielectric layer 8, a dielectric paste containing a dielectric glass frit, a resin, and a solvent is used. First, the dielectric paste is applied onto front glass substrate 3 by die-coating so as to have a predetermined thickness to cover scan electrode 4, sustain electrode 5, and black stripe 7. Then, the solvent is removed from the dielectric paste in a furnace. Finally, the dielectric paste is fired at a predetermined temperature in the furnace. That is, the resin is removed from the dielectric paste. In addition, the dielectric glass frit melts. The molten dielectric glass frit becomes glass after fired. Through the above steps, dielectric layer 8 is formed. Here, the dielectric paste may be applied by screen printing, or spin-coating other than the die-coating. In addition, a film used as dielectric layer 8 may be formed by CVD (Chemical Vapor Deposition) without using the dielectric paste. Dielectric layer 8 will be described below in detail.

Then, in a protective layer forming step, protective layer 9 is formed on dielectric layer 8. Protective layer 9 and the protective layer forming step will be described below in detail.

Then, in a film forming step, film 17 of the water molecule or hydroxide is formed on protective layer 9 which will be described below. The film forming step and a method for removing the film will be described below in detail.

Through the above steps, scan electrode 4, sustain electrode 5, black stripe 7, dielectric layer 8, and protective layer 9 are formed on front glass substrate 3, whereby front plate 2 is completed.

Next, a rear plate producing step will be described. Data electrode 12 is formed on rear glass substrate 11 by photolithography. As a material of data electrode 12, a data electrode paste containing Ag to ensure conductivity, a glass frit to bind Ag, a photosensitive resin, and a solvent is used. First, the data electrode paste is applied onto rear glass substrate 11 by screen printing or the like so as to have a predetermined thickness. Then, the solvent is removed from the data electrode paste in a furnace. Then, the data electrode paste is exposed with a photomask having a predetermined pattern put thereon. Then, the data electrode paste is developed, whereby a data electrode pattern is formed. Finally, the data electrode pattern is fired at a predetermined temperature in the furnace. That is, the photosensitive resin is removed from the data electrode pattern. In addition, the glass frit melts in the data electrode pattern. The molten glass frit becomes glass after fired. Through the above steps, data electrode 12 is formed. Here, the data electrode paste may be applied by sputtering, vapor deposition or the like other than the screen printing.

Then, base dielectric layer 13 is formed. As a material of base dielectric layer 13, a base dielectric paste containing a dielectric glass frit, a resin, and a solvent is used. First, the base dielectric paste is applied onto rear glass substrate 11 having data electrode 12 by screen printing or the like so as to have a predetermined thickness and to cover data electrode 12. Then, the solvent is removed from the base dielectric paste in a furnace. Finally, the base dielectric paste is fired at a predetermined temperature in the furnace. That is, the resin is removed from the base dielectric paste. In addition, the dielectric glass frits melts. The molten glass frit becomes glass after fired. Through the above steps, base dielectric layer 13 is formed. Here, the base dielectric paste may be applied by die-coating, spin-coating or the like other than the screen printing. In addition, a film used as base dielectric layer 13 may be formed by CVD without using the base dielectric paste.

Then, barrier rib 14 is formed by photolithography. As a material of barrier rib 14, a barrier rib paste containing a filler, a glass frit to bind the filler, a photosensitive resin, and a solvent is used. First, the barrier rib paste is applied onto base dielectric layer 13 by die-coating or the like so as to have a predetermined thickness. Then, the solvent is removed from the barrier rib paste in a furnace. Next, the barrier rib paste is exposed with a photomask having a predetermined pattern put thereon. Then, the barrier rib paste is developed and a barrier rib pattern is formed. Finally, the barrier rib pattern is fired at a predetermined temperature in the furnace. That is, the photosensitive resin is removed from the barrier rib pattern. In addition, the glass frit melts in the barrier rib pattern. The molten glass frit becomes glass after fired. Through the above steps, barrier rib 14 is formed. Here, sandblasting or the like may be used instead of the photolithography.

Then, phosphor layer 15 is formed. As a material of phosphor layer 15, a phosphor paste containing phosphor particles, a binder, and a solvent is used. First, the phosphor paste is applied onto base dielectric layer 13 provided between adjacent barrier ribs 14 and onto the side surface of barrier rib 14 by dispensing, so as to have a predetermined thickness. Then, the solvent is removed from the phosphor paste in a furnace. Finally, the phosphor paste is fired at a predetermined temperature in the furnace. That is, the resin is removed from the phosphor paste. Through the above steps, phosphor layer 15 is formed. Here, screen printing, ink-jet printing or the like may be used instead of the dispensing. Phosphor layer 15 will be described below in detail.

Through the above rear plate producing step, rear plate 10 having the predetermined components on rear glass substrate 11 is completed.

Then, in a frit applying step, a sealing material (not shown) is formed around rear plate 10 by dispensing. As a material of the sealing material (not shown), a sealing paste containing a glass frit, a binder, a solvent and the like is used. Then, the solvent is removed from the sealing paste in a furnace.

Then, front plate 2 and rear plate 10 are assembled. In an aligning step, front plate 2 and rear plate 10 are arranged so as to be opposed to each other so that display electrode 6 and data electrode 12 are perpendicular to each other.

Then, in a sealing and exhausting step, peripheries of front plate 2 and rear plate 10 are sealed with the glass frit, and discharge space 16 is exhausted. At this time, film 17 formed on protective layer 9 in the film forming step is removed.

Finally, in a discharge gas supplying step, the discharge gas containing Ne or Xe is sealed in discharge space 16.

Thus, PDP 1 is completed.

### 3. Detail of Dielectric Layer

Hereinafter, dielectric layer 8 will be described in detail. Dielectric layer 8 is composed of first dielectric layer 81 and second dielectric layer 82. A dielectric material of first dielectric layer 81 contains 20 wt. % to 40 wt. % of a dibismuth trioxide (Bi₂O₃), 0.5 wt. % to 12 wt. % of at least one component selected from a group consisting of a calcium oxide (CaO), a strontium oxide (SrO), and a barium oxide (BaO), and 0.1 wt. % to 7 wt. % of at least one component selected from a group consisting of a molybdenum trioxide (MoO₃), a tungsten trioxide (WO₃), a cerium dioxide (CeO₂), and a manganese dioxide (MnO₂).

In addition, instead of the group consisting of MoO₃, WO₃, CeO₂, and MnO₂, it may contain 0.1 wt. % to 7 wt. % of at least one component selected from a group consisting of a copper oxide (CuO), a dichrome trioxide (Cr₂O₃), a dicobalt trioxide (CO₂O₃), a divanadium heptaoxide (V₂O₇), and a diantimony trioxide (Sb₂O₃).

In addition, as a component other than the above components, it may contain 0 wt. % to 40 wt. % of ZnO, 0 wt. % to 35 wt. % of diboron trioxide (B₂O₃), 0 wt. % to 15 wt. % of silicon dioxide (SiO₂), and 0 wt. % to 10 wt. % of dialuminum trioxide (Al₂O₃), as a component not containing a zinc component.

The dielectric material is ground by wet jet milling or ball milling so that its average grain diameter becomes 0.5 μm to 2.5 μm, whereby dielectric material powder is produced. Then, 55 wt. % to 70 wt. % of this dielectric material powder and 30 wt. % to 45 wt. % of a binder component are kneaded well with three rolls, whereby a first dielectric layer paste to be subjected to die-coating or printing is completed.

The binder component is ethyl cellulose, terpineol containing 1 wt. % to 20 wt. % of an acrylic resin, or butyl carbitol acetate. In addition, in the paste, if needed, dioctyl phthalate, dibutyl phthalate, triphenyl phosphate, or tributyl phosphate may be added as a plasticizer. In addition, glycerol monooleate, sorbitan sesquioleate, homogenol (produced by Kao Corporation), or alkyl aryl group ester phosphate may be added as a dispersant. When the dispersant is added, printing characteristics are improved.

The first dielectric layer paste covers display electrode 6, and is printed on front glass substrate 3 by die-coating or screen printing. The printed first dielectric layer paste is dried and fired at a temperature of 575° C. to 590° C. which is a little higher than a softening point of the dielectric material, whereby first dielectric layer 81 is formed.

Next, second dielectric layer 82 will be described. A dielectric material of second dielectric layer 82 contains 11 wt. % to 20 wt. % of Bi₂O₃, 1.6 wt. % to 21 wt. % of at least one component selected from a group consisting of CaO, SrO, and BaO, and 0.1 wt. % to 7 wt. % of at least one component selected from a group consisting of MoO₃, WO₃, and CeO₂.

In addition, instead of MoO₃, WO₃, and CeO₂, it may contain 0.1 wt. % to 7 wt. % of at least one component selected from a group consisting of CuO, Cr₂O₃, CO₂O₃, V₂O₇, Sb₂O₃, and MnO₂.

In addition, as a component other than the above components, it may contain 0 wt. % to 40 wt. % of ZnO, 0 wt. % to 35 wt. % of B₂O₃, 0 wt. % to 15 wt. % of SiO₂, and 0 wt. % to 10 wt. % of Al₂O₃, as a component not containing a zinc component.

The dielectric material is ground by wet jet milling or ball milling so that its average grain diameter becomes 0.5 μm to 2.5 μm, whereby dielectric material powder is produced. Then, 55 wt. % to 70 wt. % of this dielectric material powder and 30 wt. % to 45 wt. % of a binder component are kneaded well with three rolls, whereby a second dielectric layer paste to be subjected to die-coating or printing is completed.

The binder component is ethyl cellulose, terpineol containing 1 wt. % to 20 wt. % of an acrylic resin, or butyl carbitol acetate. In addition, in the paste, if needed, dioctyl phthalate, dibutyl phthalate, triphenyl phosphate, or tributyl phosphate may be added as a plasticizer. In addition, glycerol monooleate, sorbitan sesquioleate, homogenol (produced by Kao Corporation), or alkyl aryl group ester phosphate may be added as a dispersant. When the dispersant is added, printing characteristics are improved.

The second dielectric layer paste is printed on first dielectric layer 81 by die-coating or screen printing. The printed second dielectric layer paste is dried and fired at a temperature of 550° C. to 590° C. which is a little higher than the softening point of the dielectric material, whereby second dielectric layer 82 is formed.

In addition, a film thickness of dielectric layer 8 is preferably 41 μm or less, combining thicknesses of first dielectric layer 81 and second dielectric layer 82, to ensure visible light transmission.

First dielectric layer 81 contains 20 wt. % to 40 wt. % of Bi₂O₃ which is higher than that of Bi₂O₃ contained in second dielectric layer 82, in order to prevent a reaction with Ag of bus electrodes 4b and 5b. Thus, since visible light transmission of first dielectric layer 81 is lower than visible light transmission of second dielectric layer 82, a film thickness of first dielectric layer 81 is formed to be smaller than a film thickness of second dielectric layer 82.

When a content of Bi₂O₃ of second dielectric layer 82 is 11 wt. % or less, color is not likely to be generated, but air bubbles are likely to be generated in second dielectric layer 82. Therefore, it is not preferable that the content of Bi₂O₃ is less than 11 wt. %. Meanwhile, when the content of Bi₂O₃ exceeds 40 wt. %, the color is likely to be generated, so that the visible light transmission is lowered. Therefore, it is not preferable that the content of Bi₂O₃ exceeds 40 wt. %.

In addition, as the film thickness of dielectric layer 8 decreases, brightness is improved and a discharge voltage is reduced. Therefore, the film thickness is preferably set to be smaller to the extent that a breakdown voltage is not lowered.

In view of the above description, according to this embodiment, the film thickness of dielectric layer 8 is set at 41 μm or less, in which first dielectric layer 81 is 5 μm to 15 μm in thickness, and second dielectric layer 82 is 20 μm to 36 μm in thickness.

According to PDP 1 produced as described above, it has been confirmed that dielectric layer 8 can prevent a coloring phenomenon (change into yellow) from occurring on front glass substrate 3, and air bubbles from being generated in dielectric layer 8, and is superior in breakdown voltage performance even when the Ag material is used in display electrode 6.

Next, consideration is given to a reason why the change into yellow and generation of the air bubbles are prevented in first dielectric layer 81 by the dielectric material, in PDP 1 according to this embodiment. That is, it is known that when MoO₃, or WO₃ is added into dielectric glass containing Bi₂O₃, a compound such as Ag₂MoO₄, Ag₂Mo₂O₇, Ag₂Mo₄O₁₃, Ag₂WO₄, Ag₂W₂O₇, or Ag₂W₄O₁₃ is likely to be generated at a low temperature of 580° C. or less. According to this embodiment, since the firing temperature of dielectric layer 8 is 550° C. to 590° C., silver ions (Ag⁺) diffused in dielectric layer 8 during the firing process react with MoO₃, WO₃, CeO₂, or MnO₂ in dielectric layer 8, generate a stable compound, and are stabilized. That is, since the Ag⁺ are stabilized without being reduced, they are not aggregated and do not generate colloid. Therefore, since Ag⁺ is stabilized, oxygen generation due to the colloid of Ag is reduced, so that the generation of the air bubbles is reduced in dielectric layer 8.

Meanwhile, in order to efficiently provide the above effect, the content of MoO₃, WO₃, CeO₂, or MnO₂ is preferably 0.1 wt. % or more, or more preferably 0.1 wt. % to 7 wt. %, in the dielectric glass containing Bi₂O₃. Here, when the content is less than 0.1 wt. %, the change into yellow is less prevented, and when the content exceeds 7 wt. %, the glass is uncomfortably colored.

That is, according to dielectric layer 8 of PDP 1 in this embodiment, first dielectric layer 81 which is in contact with bus electrodes 4b and 5b composed of the Ag material prevents the change into yellow and air bubble generation, and second dielectric layer 82 provided on first dielectric layer 81 achieves the high light transmission. As a result, dielectric layer 8, as a whole, can prevent the air bubbles and change into yellow from being generated and achieve high transmission in the PDP.

### 4. Detail of protective layer

Protective layer 9 includes base film 91 serving as the base layer and aggregated particles 92. Base film 91 includes at least a first metal oxide and a second metal oxide. The first metal oxide and the second metal oxide are composed of two kinds of components selected from a group of MgO, CaO, SrO and BaO. In addition, base film 91 has at least one peak through an X-ray diffraction analysis. This peak exists between a first peak of the first metal oxide through an X-ray diffraction analysis and a second peak of the second metal oxide through an X-ray diffraction analysis. The first peak and the second peak show the same surface orientation as a surface orientation shown by the peak of base film 91.

### [4-1. Detail of Base Film]

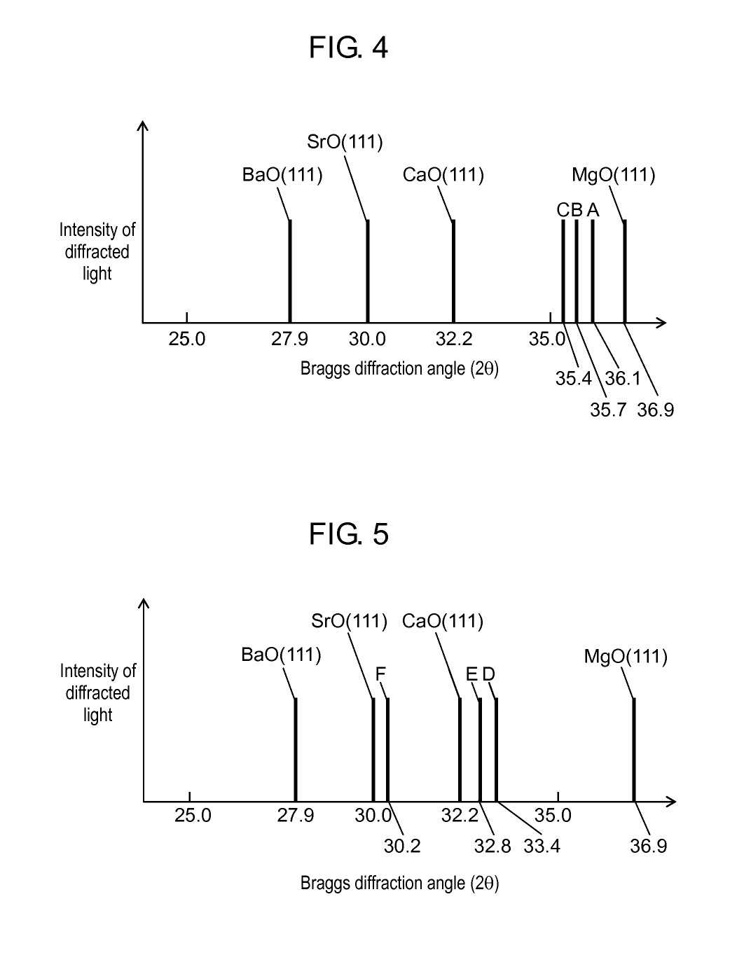

FIG. 4 shows an X-ray diffraction result on the surface of base film 91 composing the protective layer 9 of PDP 1 according to this embodiment. In addition, FIG. 4 also shows a result of X-ray diffraction analyses of MgO simple substance, CaO simple substance, SrO simple substance, and BaO simple substance.

Referring to FIG. 4, a horizontal axis shows a Braggs diffraction angle (2θ), and a vertical axis shows intensity of an X-ray diffraction wave. A unit of the diffraction angle is represented by a degree in a case where one circle is 360 degrees, and the intensity is represented by an arbitrary unit. A crystal orientation as a specific orientation is shown in parentheses.

As shown in FIG. 4, in the surface orientation of (111), the CaO simple substance has a peak at a diffraction angle of 32.2 degrees. The MgO simple substance has a peak at a diffraction angle of 36.9 degrees. The SrO simple substance has a peak at a diffraction angle of 30.0 degrees. The BaO simple substance has a peak at a diffraction angle of 27.9 degrees.

According to PDP 1 in this embodiment, base film 91 of protective layer 9 contains at least two metal oxides selected from the group of MgO, CaO, SrO, and BaO.

FIG. 4 shows the X-ray diffraction result in a case where the two simple substance components compose base film 91. A point A shows an X-ray diffraction result of base film 91 composed of the MgO simple substance and the CaO simple substance as the simple substance components. A point B shows an X-ray diffraction result of base film 91 composed of the MgO simple substance and the SrO simple substance as the simple substance components. A point C shows an X-ray diffraction result of base film 91 composed of the MgO simple substance and the BaO simple substance as the simple substance components.

As shown in FIG. 4, in the surface orientation of (111), the point A has a peak at a diffraction angle of 36.1 degrees. The MgO simple substance serving as the first metal oxide has the peak at the diffraction angle of 36.9 degrees. The CaO simple substance serving as the second metal oxide has the peak at the diffraction angle of 32.2 degrees. That is, the peak of the point A exists between the peak of the MgO simple substance and the peak of the CaO simple substance. Similarly, a peak of the point B is provided at a diffraction angle of 35.7 degrees, and it exists between the peak of the MgO simple substance serving as the first metal oxide, and the peak of the SrO simple substance serving as the second metal oxide. A peak of the point C is provided at a diffraction angle of 35.4 degrees, and it exists between the peak of the MgO simple substance serving as the first metal oxide and the peak of the BaO simple substance serving as the second metal oxide.

In addition, FIG. 5 shows an X-ray diffraction result in a case where the three or more simple substances compose base film 91. A point D shows an X-ray diffraction result of base film 91 composed of MgO, CaO, and SrO as the simple substances. A point E shows an X-ray diffraction result of base film 91 composed of MgO, CaO, and BaO as the simple substances. A point F shows an X-ray diffraction result of base film 91 composed of CaO, SrO, and BaO as the simple substances.

As shown in FIG. 5, in the surface orientation of (111), the point D has a peak at a diffraction angle of 33.4 degrees. The MgO simple substance serving as the first metal oxide has the peak at the diffraction angle of 36.9 degrees. The SrO simple substance serving as the second metal oxide has the peak at the diffraction angle of 30.0 degrees. That is, the peak of the point D exists between the peak of the MgO simple substance and the peak of the SrO simple substance. Similarly, a peak of the point E is provided at a diffraction angle of 32.8 degrees, and it exists between the peak of the MgO simple substance serving as the first metal oxide, and the peak of the BaO simple substance serving as the second metal oxide. A peak of the point F is provided at a diffraction angle of 30.2 degrees, and it exists between the peak of the CaO simple substance serving as the first metal oxide and the peak of the BaO simple substance serving as the second metal oxide.

Thus, base film 91 of PDP 1 in this embodiment includes at least the first metal oxide and the second metal oxide. In addition, base film 91 has at least one peak through the X-ray diffraction analysis. This peak exists between the first peak of the first metal oxide through an X-ray diffraction analysis and the second peak of the second metal oxide through an X-ray diffraction analysis. The first peak and the second peak show the same surface orientation as the surface orientation shown by the peak of base film 91. The first metal oxide and the second metal oxide are composed of two kinds of components selected from the group of MgO, CaO, SrO, and BaO.

In addition, the description has been made using the crystal surface orientation of (111) in the above, but even when another surface orientation is used, the position of the peak of the metal oxide is the same as above.

Depths of CaO, SrO, and BaO from a vacuum level are smaller than that of MgO. Therefore, when PDP 1 is driven, it is considered that the number of electrons discharged due to the Auger effect while the electrons existing in energy levels of CaO, SrO, and BaO are moved to the ground state of the Xe ion is greater than that of the electrons which are moved from an energy level of MgO.

In addition, as described above, the peak of base film 91 in this embodiment exists between the peak of the first metal oxide and the peak of the second metal oxide. That is, it is considered that the energy level of base film 91 exists between the simple metal oxides, and the number of electrons discharged due to the Auger effect is greater than that of the electrons which are moved from the energy level of MgO.

As a result, compared to the MgO simple substance, base film 91 can show preferable secondary electron emission characteristics, so that it can reduce a sustain voltage. Therefore, when Xe partial pressure is increased as a discharge gas to enhance the brightness especially, the discharge voltage is lowered, and high-brightness and low-voltage PDP 1 can be realized.

Table 1 shows a result of a sustain voltage obtained when a mixture gas (Xe, 15%) of Xe and Ne is sealed at 60 kPa, while changing the composition of base film 91, in PDP 1 in this embodiment.

### [Table 1]

In addition, the sustain voltage in Table 1 is represented by a relative value when a value of a comparative example is set at “100”. Base film 91 of sample A is composed of MgO and CaO. Base film 91 of sample B is composed of MgO and SrO. Base film 91 of sample C is composed of MgO and BaO. Base film 91 of sample D is composed of MgO, CaO, and SrO. Base film 91 of sample E is composed of MgO, CaO, and BaO. In addition, as for the comparative example, base film 91 is formed of the MgO simple substance.

When the partial pressure of Xe of the discharge gas is increased from 10% to 15%, the brightness is increased by about 30%, but the sustain voltage is increased by about 10%, in the comparative example in which base film 91 is composed of MgO simple substance.

Meanwhile, according to the PDP in this embodiment, the sustain voltages in sample A, sample B, sample C, sample D, and sample E can be all reduced by about 10% to 20% compared to the comparative example. Therefore, they can be a sustain voltage within a normal operation range, so that the PDP can be high in brightness and driven at low voltage.

In addition, CaO, SrO, or BaO is high in reactivity when it is provided as the simple substance, so that it is likely to react with the impurity, and the electron emission performance is problematically lowered. However, according to this embodiment, since the metal oxides are combined, a crystal structure is provided so that the reactivity is lowered, the impurity is hardly mixed, and an oxygen defect is small. Therefore, the electrons are prevented from being emitted excessively when the PDP is driven, and in addition to both effects of the low voltage drive and the secondary electron emission performance, an effect of appropriate electron retaining characteristics can be provided. The electron retaining characteristics are especially very effective when under the condition that wall charges stored in an initializing period are retained, an address discharge is surely performed while preventing an address defect during an address period.

### [4-2. Detail of Aggregated Particle]

Next, aggregated particle 92 provided on base film 91 according to this embodiment will be described in detail.

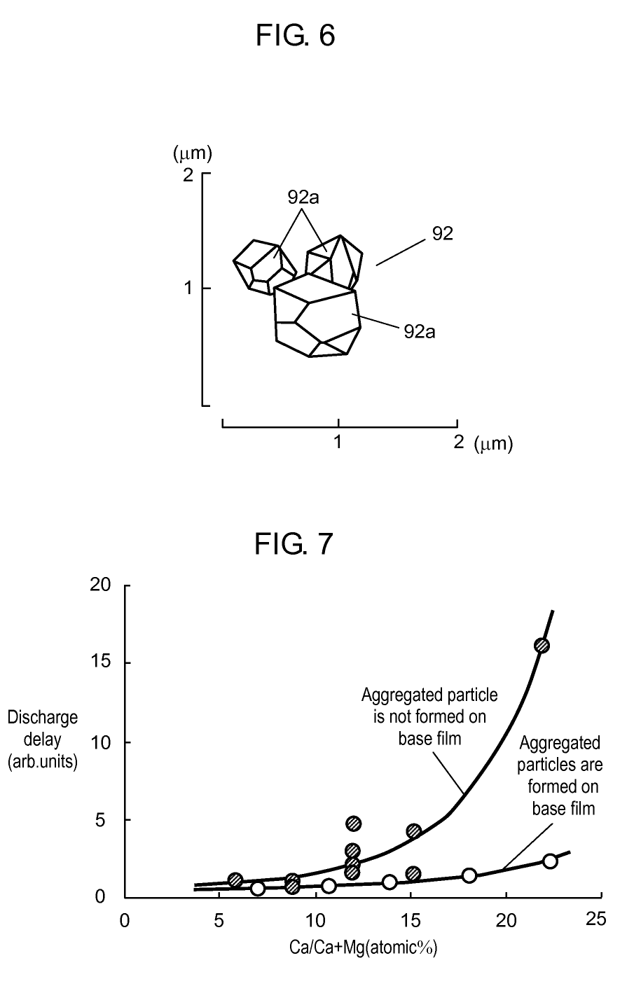

As shown in FIG. 6, aggregated particle 92 is formed of aggregated crystal particles 92a of MgO. Its shape can be confirmed under a scanning type electron microscope (SEM). According to this embodiment, the aggregated particles 92 are arranged so as to be dispersed over the whole surface of base film 91.

Aggregated particle 92 has an average particle diameter of 0.9 μm to 2.5 μm. In this embodiment, the average particle diameter means a volume accumulation average diameter (D50). In addition, the average particle diameter is measured by a laser diffraction type particle size distribution measurement device MT-3300 (produced by Nikkiso Co., Ltd.).

Aggregated particles 92 are not connected by strong bonding force as a solid. Aggregated particle 92 is composed of a plurality of primary particles bonded by static electricity or van der Waals' force. In addition, the aggregated particle 92 is partially or wholly decomposed to the state of the primary particle by external force such as an ultrasonic wave. Aggregated particle 92 has the average particle diameter of about 1 μm, and crystal particle 92a is in the form of a polyhedron having seven or more flat faces such as a tetradodecahedron or dodecahedron. In addition, crystal particle 92a can be produced by gas phase synthesis or precursor firing which will be described below.

According to the gas phase synthesis, a magnesium (Mg) metal material having purity of 99.9% or more is heated in an atmosphere filled with an inert gas. Then, it is heated in an atmosphere added with a little amount of oxygen, so that Mg is directly oxidized. Thus, crystal particle 92a of MgO is produced.

Meanwhile, according to the precursor firing, crystal particle 92a is produced by a following method. According to the precursor firing, a precursor of MgO is uniformly fired at a high temperature of 700° C. or more. Then, the fired MgO is gradually cooled down, whereby crystal particle 92a of MgO is produced. The precursor may be a compound composed of at least one kind of components selected from a group consisting of magnesium alkoxide (Mg(OR)₂), magnesium acetylacetone (Mg(acac)₂), magnesium hydroxide (Mg(OH)₂), magnesium carbonate (MgCo₂), magnesium chloride (MgCl₂), magnesium sulfate (MgSO₄), magnesium nitrate (Mg(NO₃)₂), and magnesium oxalate (MgC₂O₄).

In addition, depending on the selected compound, the compound takes the form of a hydrate in a normal state, and the hydrate may be used. The compound is adjusted such that purity of MgO obtained after fired is to be 99.95% or more, or preferably 99.98% or more. When a certain amount or more of an impurity element of alkali metal such as B, Si, Fe, or Al is mixed in the compound, the particles are unnecessarily bonded to each other or fired during the heat treatment, and in this case, it is hard to obtain crystal particle 92a of MgO having high crystallinity. Thus, it is necessary to previously adjust the precursor by removing the impurity element. By adjusting a firing temperature or a firing atmosphere in the precursor firing, the particle diameter can be controlled. The firing temperature can be selected within a range of 700° C. to 1500° C. When the firing temperature is 1000° C. or more, a primary particle diameter can be controlled to be 0.3 to 2 μm. A plurality of primary particles of crystal particles 92a is aggregated to each other while being generated by the precursor firing to become aggregated particle 92.

It has been confirmed that aggregated particle 92 of MgO provides an effect to prevent a discharge delay mainly generated in the address discharge, and an effect to improve temperature dependency of the discharge delay, through experiments by the present inventor. Thus, according to this embodiment, since aggregated particle 92 has a feature superior in initial electron emission characteristics, compared to base film 91, it is arranged as a part to supply an initial electron required when a discharge pulse rises.

It is considered that the discharge delay is mainly caused by deficiency in amount of initial electrons emitted from the surface of base film 91 to discharge space 16 to serve as a trigger at the start of discharge. Thus, aggregated particles 92 of MgO are dispersed on the surface of base film 91 in order to contribute to stable supply of the initial electrons to discharge space 16. Thus, the electrons sufficiently exist in discharge space 16 when the discharge pulse rises, so that the problem of the discharge delay can be solved. Therefore, due to the initial electron emission characteristics, high-definition PDP 1 is also superior in discharge responsiveness and can be driven at high speed. In addition, when aggregated particles 92 of the metal oxide are arranged on the surface of base film 91, in addition to the main effect to prevent the discharge delay in the address discharge, the effect to improve the temperature dependency of the discharge delay is provided.

As described above, PDP 1 in this embodiment includes base film 91 which provides both effects of the low voltage driving and the charge retention, and aggregated particles 92 of MgO which provides the effect of the prevention of the discharge delay, so that the high-definition PDP can be driven at high speed and low voltage in PDP 1 as a whole, and high-grade image display performance can be realized by preventing a lighting defect.

### [4-3. Experiment 1]

FIG. 7 is a view showing a relationship between a discharge delay generated when base film 91 is composed of MgO and CaO among PDPs 1 according to this embodiment, and a concentration of calcium (Ca) in protective layer 9. Thus, base film 91 is composed of MgO and CaO, and base film 91 has the peak between the diffraction angle at the peak of MgO and the diffraction angle at the peak of CaO, through an X-ray diffraction analysis.

In addition, FIG. 7 shows a case where protective layer 9 is only composed of base film 91, and the case where aggregated particles 92 are arranged on base film 91, and the discharge delay is represented, based on a case where Ca is not contained in base film 91.

As can be clearly understood from FIG. 7, according to the case where only base film 91 is provided, and the case where aggregated particles 92 are arranged on base film 91, while as the Ca concentration increases, the discharge delay increases in the case where only base film 91 is provided, the discharge delay can be considerably prevented from increasing and the discharge delay hardly changes even when the Ca concentration increases in the case where aggregated particles 92 are arranged on base film 91.

### [4-4. Experiment 2]

Next, a description will be made of a result of an experiment performed to confirm the effect of PDP 1 having protective layer 9 according to this embodiment.

First, PDPs 1 having different protective layers 9 are produced experimentally. Sample 1 is PDP 1 in which protective layer 9 is only formed of MgO. Sample 2 is PDP 1 in which protective layer 9 is formed of MgO doped with an impurity such as Al or Si. Sample 3 is PDP 1 in which only primary particles of crystal particles 92a formed of MgO are dispersed and attached on protective layer 9 formed of MgO.

Meanwhile, sample 4 is PDP 1 according to this embodiment. Sample 4 is PDP 1 in which aggregated particles 92 composed of aggregated crystal particles 92a formed of MgO and having the same particle diameter are dispersed all over base film 91 formed of MgO. Sample A described above is used for protective layer 9. That is, protective layer 9 is composed of base film 91 composed of MgO and CaO, and aggregated particles 92 composed of aggregated crystal particles 92a uniformly distributed all over base film 91. In addition, base film 91 has the peak between the peak of the first metal oxide and the peak of the second metal oxide of base film 91, through the X-ray diffraction analysis of the surface of base film 91. That is, the first metal oxide is MgO, and the second metal oxide is CaO. Thus, the diffraction angle of the peak of MgO is 36.9 degrees, the diffraction angle of the peak of CaO is 32.2 degrees, and the diffraction angle of the peak of base film 91 is 36.1 degrees.

Electron emission performance and charge retention performance are measured on PDPs 1 having four kinds of protective layers.

In addition, as for the electron emission performance, as its value increases, an electron emission amount increases. The electron emission performance is expressed by an initial electron emission amount determined by a surface state of the discharge, a gas kind, and its state. The initial electron emission amount can be obtained by measuring an electronic current amount emitted from the surface when the surface is irradiated with an ion or electron beam. However, it is difficult to make a measurement by a nondestructive way. Thus, a method disclosed in Unexamined Japanese Patent Publication No. 2007-48733 is used. That is, among the delay times at the time of discharge, a value which is an indication of ease of discharge generation, called a statistical delay time is measured. When an inverse number of the statistical delay time is integrated, an obtained value linearly corresponds to the emission amount of the initial electrons. The delay time at the time of discharge corresponds to a time from rising of an address discharge pulse until the address discharge is generated later. The discharge delay is supposed to be mainly caused because the initial electron serving as the trigger to generate the address discharge is not easily emitted from the protective layer surface to the discharge space.

The charge retention performance is expressed, as its index, by a voltage value of a voltage (hereinafter, referred to as the Vscn lighting voltage) applied to the scan electrode to prevent a charge emission phenomenon in PDP 1. That is, the lower the Vscn lighting voltage is, the higher the charge retention ability is. When the Vscn lighting voltage is low, the PDP can be driven at a low voltage. Thus, a component which is low in breakdown voltage and low in capacity can be used as a power supply or an electric component. As for a current product, an element having a breakdown voltage as low as 150 V is used as a semiconductor switching element such as a MOSFET provided to sequentially apply the scan voltage to the panel. The Vscn lighting voltage is preferably suppressed to 120 V or lower in view of a variation due to temperature.

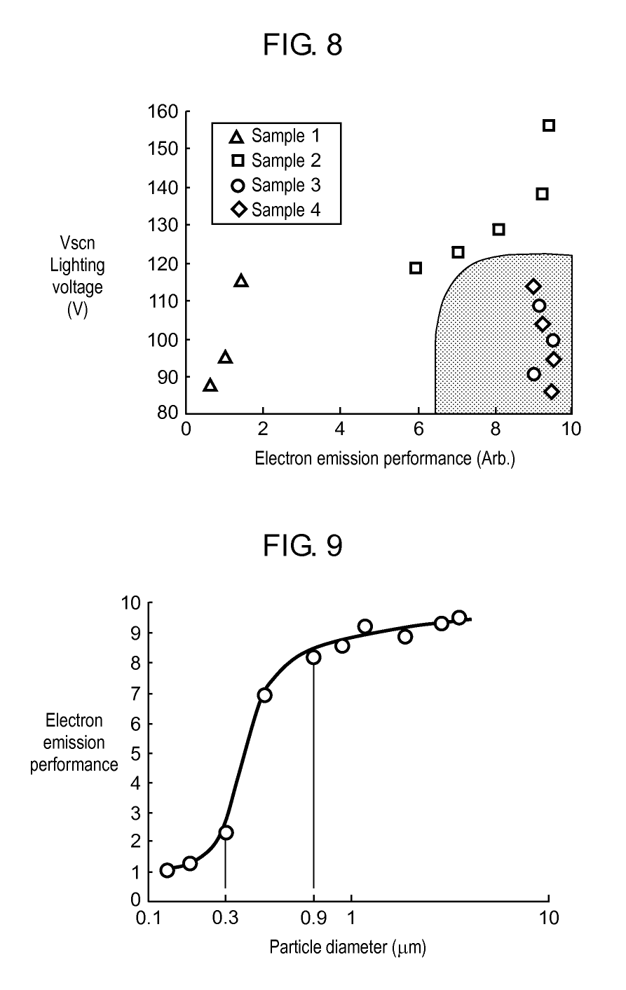

As can be clearly understood from FIG. 8, as for sample 4, the Vscn lighting voltage can be 120 V or less in the evaluation of the charge retention performance, and the electron emission performance is considerably preferable as compared with sample 1 in which the protective layer is only composed of MgO.

In general, the electron emission ability of the protective layer of the PDP contradicts with the charge retention ability thereof. The electron emission performance can be improved by changing a condition for forming the protective layer, or doping an impurity such as Al, Si, or Ba in the protective layer in a film formation process. However, the Vscn lighting voltage also rises as an adverse effect.

According to the PDP having protective layer 9 in this embodiment, the electron emission ability is 8 or more, and as for the charge retention ability, the Vscn lighting voltage is 120 V or less. That is, protective layer 9 can be provided with the electron emission ability and the charge retention ability which can cope with the PDP in which the number of scan lines is great due to high definition, and a cell size tends to be miniaturized.

### [4-5. Experiment 3]

Next, a detailed description will be made of the particle diameter of aggregated particle 92 used in protective layer 9 of PDP 1 according to this embodiment. In addition, in the following description, the particle diameter means the average particle diameter, and the average particle diameter means the volume accumulation average diameter (D50).

FIG. 9 shows a result of an experiment to examine the electron emission performance of protective layer 9 while changing the average particle diameter of aggregated particle 92 of MgO. In FIG. 9, the average particle diameter of aggregated particle 92 is measured by observing aggregated particle 92 under the SEM.

As shown in FIG. 9, when the average particle diameter is as small as 0.3 μm, the electron emission performance is low, and when it is approximately 0.9 μm or more, the electron emission performance can be high.

In order to increase the number of emitted electrons in the discharge cell, the number of crystal particles per unit area of protective layer 9 is preferably large. According to an experiment made by the present inventors, when crystal particle 92a exists in a part corresponding to a top of barrier rib 14 which is closely in contact with protective layer 9, it could damage the top of barrier rib 14. In this case, it is found that a material of damaged barrier rib 14 covers the phosphor, so that the corresponding cell is not normally turned on or off. The damage in the barrier rib is not likely to be caused when crystal particle 92a does not exist at the part corresponding to the barrier rib top, so that as the number of attached crystal particles increases, a probability of damage generation of barrier rib 14 becomes high.

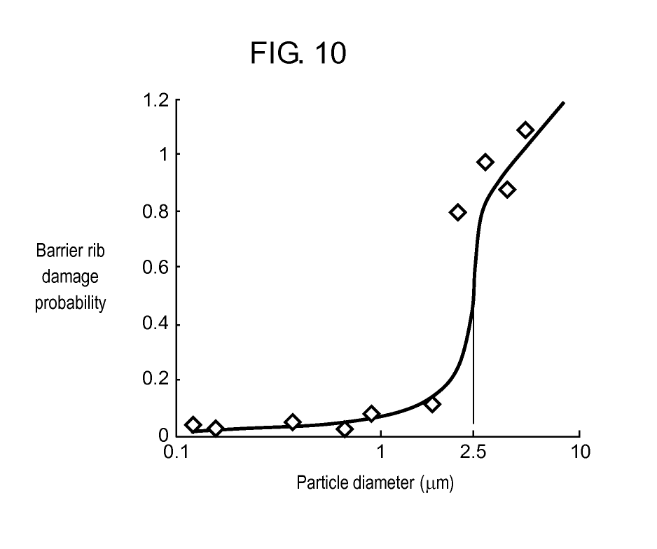

FIG. 10 shows a result of an experiment to examine the probability of barrier rib damage while changing the average particle diameter of aggregated particle 92. As shown in FIG. 10, when the average particle diameter of aggregated particle 92 is increased to as large as 2.5 μm, the barrier rib damage probability abruptly increases, and when it is smaller than 2.5 μm, the barrier rib damage probability can be relatively low.

As described above, according to PDP 1 having protective layer 9 in this embodiment, the electron emission ability is 8 or more, and as for the charge retention ability, the Vscn lighting voltage is 120 V or less.

In addition, while the description has been made with the MgO particles as crystal particles 92a in the above, the kind of the particle is not limited to MgO because the same effect can be also provided with a crystal particle of a metal oxide such as Sr, Ca, Ba, or Al having high electron emission performance like MgO.

### 5. Detail of protective layer forming step

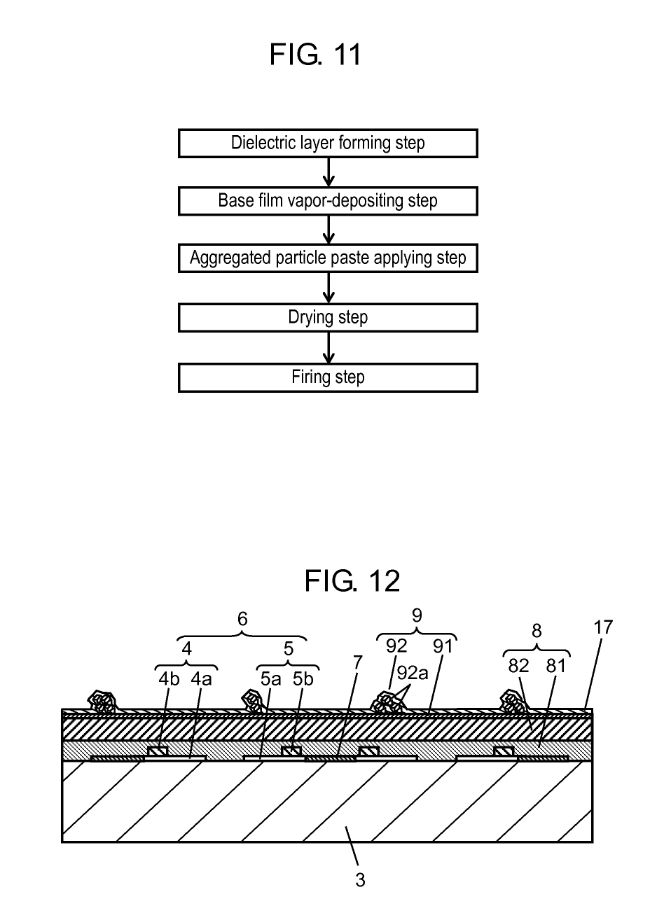

Next, a description will be made of steps of producing protective layer 9 in PDP 1 according to this embodiment, with reference to FIG. 11.

As shown in FIG. 11, after the dielectric layer forming step to form dielectric layer 8, base film 91 is formed on dielectric layer 8 by vacuum vapor deposition, in the protective layer forming step. A raw material of the vacuum vapor deposition is a pellet of a material of the MgO simple substance, CaO simple substance, SrO simple substance, or BaO simple substance, or a pellet formed by mixing the above materials. The method may be electron beam vapor deposition, sputtering, or ion plating.

Then, aggregated particles 92 are discretely applied and attached on base film 91 before fired. That is, aggregated particles 92 are dispersed over the whole surface of base film 91.

In this step, first, aggregated particle paste is made by mixing aggregated particles 92 in an organic solvent. Then, the aggregated particle paste is applied on base film 91 in an aggregated particle paste applying step, whereby an aggregated particle paste film having an average film thickness of 8 μm to 20 μm is formed. In addition, the method for applying the aggregated particle paste on base film 91 may include screen printing, spraying, spin-coating, die-coating, and slit-coating.

Here, the solvent used in producing the aggregated particle paste preferably has high affinity with base film 91 and aggregated particle 92 of MgO, and has vapor pressure of several tens of Pa at normal temperature to easily remove vapor in a next drying step. For example, an organic solvent simple substance such as methoxy methyl butanol, terpineol, propylene glycol, or benzyl alcohol, or their mixed solvent may be used. Viscosity of the paste containing the above solvent is several mPa·s to several tens of mPa·s.

The substrate having the aggregated particle paste is immediately moved to the drying step. The aggregated particle paste film is dried under reduced pressure in the drying step. More specifically, the aggregated particle paste film is rapidly dried within several tens of seconds in a vacuum chamber. Thus, convection which is noticeably generated in a drying process by heating is not generated. Therefore, aggregated particles 92 are more uniformly attached on base film 91. In addition, the drying method in this drying step may be performed by heating, depending on the solvent used in producing the aggregated particle paste.

Then, unfired base film 91 formed in the base film vapor deposition step, and the aggregated particle paste film subjected to the drying step are fired at a temperature of several hundreds of degrees at the same time in a firing step. Through the firing step, the solvent and the resin component are removed from the aggregated particle paste film. As a result, aggregated particles 92 composed of polyhedral crystal particles 92a are attached on base film 91, whereby protective layer 9 is completed.

According to this method, aggregated particles 92 can be diffused all over base film 91.

In addition, other than the above method, without using the solvent, a method for directly spraying a particle group together with a gas, or a method for simply diffusing it by use of gravity may be used.

### 6. Detail of Film Forming Step

Next, the film forming step will be described below in detail. As shown in FIG. 3, the film forming step is performed after the protective layer forming step in this embodiment.

First, front plate 2 on which protective layer 9 has been formed is conveyed to a vacuum device. Then, the vacuum device is exhausted and decompressed to about 1×10⁻² Pa. Then, a nitrogen gas which has bubbled in water is introduced thereto. The nitrogen gas is at 25° C. after bubbling in pure water at 25° C. and contains a water molecule until a dew-point temperature becomes 15° C. An inner pressure of the vacuum device is increased to about 0.1 MPa. Thus, a nitrogen gas atmosphere containing the water molecule is provided in the vacuum device. Then, a temperature in the vacuum device is increased and maintained at 400° C. for 10 minutes. Thus, front plate 2 is fired. At this time, protective layer 9 is cleaned. Here, the cleaning is performed to remove the impurity such as CO series impurity or CH series impurity attached on the surface of protective layer 9. When protective layer 9 is cleaned, it is preferably fired in a gas atmosphere such as a vacuum, nitrogen gas, mixture gas of nitrogen and oxygen, or rare gas atmosphere. Protective layer 9 can be also cleaned when fired in an atmosphere such as the nitrogen gas containing water molecule, the mixture gas of nitrogen and oxygen, or the rare gas atmosphere. Therefore, in the film forming step in this embodiment, protective layer 9 can be cleaned when front plate 2 is fired in the atmosphere of the nitrogen gas containing the water molecule. In addition, a firing temperature of front plate 2 is preferably maintained at a temperature in a range of 350° C. to 500° C. When the firing temperature of front plate 2 is lower than 350° C., protective layer 9 is not sufficiently cleaned, which is not preferable. Meanwhile, when the firing temperature of front plate 2 is higher than 500° C., front glass substrate 3 starts softening and deforming, which is not preferable.

Then, the temperature in the vacuum device is lowered to 200° C. or less, without changing the atmosphere at the time of firing. According to this embodiment, the temperature in the vacuum device is lowered to room temperature. Then, the water molecule contained in the nitrogen gas is adsorbed in the surface of protective layer 9. Thus, as shown in FIG. 12, the water molecule becomes a liquid phase, and film 17 of the water molecule or a hydroxide is formed so as to cover whole protective layer 9. Through the above steps, the step for forming the film of the water molecule or hydroxide on protective layer 9 is completed. The atmosphere in the vacuum device is to be the atmosphere containing at least one selected from a group consisting of the nitrogen gas, the mixture gas of nitrogen and oxygen, and the rare gas, and the water molecule.

### [6-1. Method for Removing Film]

When film 17 of the water molecule or hydroxide formed on protective layer 9 remains in the PDP, the discharge voltage is fluctuated, and sputtering resistance performance of protective layer 9 is problematically deteriorated. Thus, it is necessary to remove film 17 in the steps for producing PDP 1 before the discharge gas is sealed. According to this embodiment, film 17 is removed from protective layer 9, and the water molecule is exhausted from discharge space 16 in the sealing and exhausting step. Hereinafter, a method for removing the film will be described.

First, in the aligning step, front plate 2 having film 17 and rear plate 10 are oppositely arranged. At this time, front plate 2 and rear plate 10 are oppositely arranged across the sealing material provided around the substrate, temporarily fixed by a clip, and set in a sealing oven. Rear plate 10 has an exhaust tube made of a glass material which can be connected to discharge space 16 through an exhaust hole. The exhaust tube is connected to an exhaust device provided in the panel and a discharge gas introduction device. As the sealing material, low-melting-point glass having a softening point temperature of 380° C. is used.

Then, in the sealing and exhausting step, film 17 is removed from protective layer 9, and the water molecule is exhausted from discharge space 16 by heating oppositely arranged front plate 2 and rear plate 10.

First, an inner pressure of the sealing oven is reduced and exhausted to about 1×10⁻² Pa. At this time, since rear plate 10 and front plate 2 are not sealed yet, discharge space 16 and the sealing oven have the same pressure.

Next, the sealing oven is heated until front plate 2 and rear plate 10 reach 330° C. which is lower than the softening point temperature of 380° C. of the sealing material and is required for film 17 to be removed and held at that temperature for 10 minutes while continuing to exhaust the sealing oven. Thus, film 17 formed on protective layer 9 is removed from the surface of protective layer 9 as the water molecule and exhausted from discharge space 16. Since adsorption force of film 17 formed on the surface of protective layer 9 is weak compared to adsorption force of the CO series impurity or the CH series impurity, film 17 can be removed at a relatively low temperature.

Then, the sealing oven is heated until front plate 2 and rear plate 10 reaches a temperature higher than the softening point temperature of 380° C. of the sealing material, such as 420° C. and held at the temperature for about 10 minutes while continuing to exhaust discharge space 16. Through this step, the sealing material sufficiently melts. Then, the sealing oven is lowered to 300° C. which is lower than the softening point temperature of the sealing material, whereby the sealing and exhausting step for front plate 2 and rear plate 10 is completed.

In addition, discharge space 16 is continuously exhausted to about 1×10⁻⁴ Pa, and the discharge gas is introduced to discharge space 16 by the discharge gas introduction device. The discharge gas such as a mixture gas of Ne and Xe is introduced at a pressure of 66.5 kPa, the exhaust tube is sealed, and front plate 2 and rear plate 10 are taken out of the sealing device.

Through the above steps, the front plate 2 from which film 17 has been removed and rear plate 10 are sealed, whereby PDP 1 is completed.

### [6-2. Experiment 4]

Next, a description will be made of an experiment result performed to confirm an effect of the production method according to this embodiment. After protective layer 9 has been formed, samples are prepared while changing the firing atmosphere of front plate 2, and the samples are measured by thermal desorption spectroscopy (TDS). The prepared samples are three kinds of samples in a working example, comparative example 1, and comparative example 2. According to the working example, the sample is formed such that after the protective layer forming step, the above-described film forming step is performed and the sample is exposed to the air. According to comparative example 1, the sample is formed such that after protective layer 9 has been formed, front plate 2 after exposed to the air is fired at 400° C. in the vacuum device to which a nitrogen gas has been introduced, the temperature is lowered to room temperature without changing the atmosphere, and the sample is exposed to the air. According to comparative example 2, the sample is formed such that after protective layer 9 has been formed, the sample is exposed to the air. In addition, a circumstance of the air to which the samples are exposed is an atmosphere in which temperature is 25° C. and moisture is 40%.

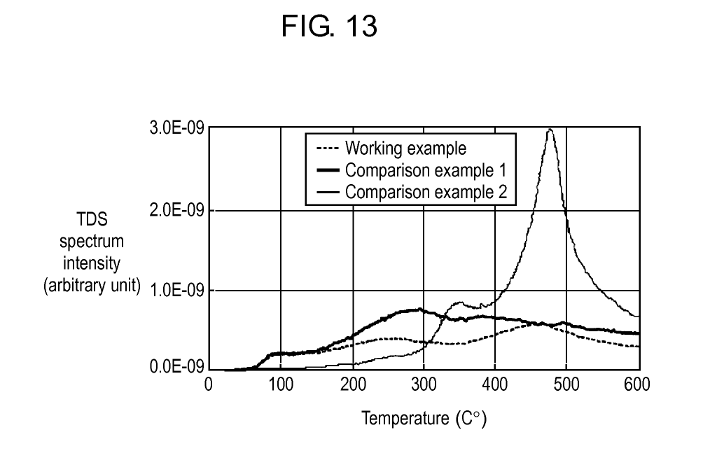

FIG. 13 shows a result of the TDS measurement. FIG. 13 shows intensity of mass number 44 (CO₂). In the TDS measurement, WA1000S (produced by ESCO, Ltd) is used. A pressure in a measurement chamber is 1×10⁻⁷ Pa. A measurement sample is cut to approximately 1 cm cube, and arranged on a quartz stage set in the chamber with protective layer 9 side up. A quadrupole mass spectrometer serving as a measurement device is arranged in an upper part of the chamber. The sample is heated up by infrared rays. A rate of temperature rise is 1° C./s. A temperature of the sample is measured by a thermoelectric couple buried in the quartz stage. The sample is heated from room temperature to 600° C. An integral value of a detected intensity value from room temperature to 600° C. represents the intensity.

As shown in FIG. 13, as for the samples of working example 1 and comparative example 1 are considerably reduced in CO₂ elimination amount compared to the sample of comparative example 2. This shows that the surface of protective layer 9 is cleaned in each of the working example and comparative example 1. That is, it shows that cleaning can be also performed when fired in the atmosphere of the nitrogen gas containing the water molecule. In addition, as for the sample of the working example, it is found that the CO₂ elimination amount is smaller than the sample of comparative example 1, at a temperature in a range of 20° C. to 480° C. actually used in the production process. This shows that protective layer 9 after the film forming step prevents the CO series impurity or the CH series impurity from being attached thereon even after exposed to the air because it is covered with film 17. The CO series impurity or the CH series impurity attached on protective layer 9 is removed at the time of discharging and becomes a carbon dioxide (CO₂) in discharge space 16. Base film 91 composed of MgO, CaO, SrO, or BaO reacts with CO₂, and its surface is easily altered, so that the secondary electron emission ability is deteriorated. Therefore, the sustain voltage is gradually increased in a life test of PDP 1.

However, according to PDP 1 produced by the production method of this embodiment, since film 17 is formed on cleaned protective layer 9, the CO series impurity or the CH series impurity are prevented from being attached on base film 91. Therefore, base film 91 of this embodiment can prevent the secondary electron emission ability from being deteriorated due to a long-time use. Thus, according to PDP 1 produced by the production method in this embodiment, base film 91 is prevented from being deteriorated and the sustain voltage can be reduced.

In addition, according to PDP 1 produced by the production method in this embodiment, front plate 2 on which protective layer 9 has been formed is fired in the atmosphere of the nitrogen gas containing the water molecule to clean protective layer 9, and to form film 17 of the water molecule or hydroxide on the surface of protective layer 9. That is, according to the production method in this embodiment, the step for cleaning protective layer 9, and the step for forming film 17 on the surface of protective layer 9 without being exposed to the air after protective layer 9 has been cleaned can be performed at the same time. Therefore, it is not necessary to change the atmosphere of the substrate between these steps, so that a production facility can be simplified.

Furthermore, according to the production method in this embodiment, since film 17 is formed on the surface of protective layer 9 after protective layer 9 has been cleaned, the CO series impurity or the CH series impurity can be prevented from being adsorbed. Thus, the CO series impurity or the CH series impurity can be prevented from being introduced into discharge space 16. Thus, the protective layer 9 is prevented from being altered which is caused because the CO series impurity or the CH series impurity is attached to protective layer 9. In addition, a carrier atmosphere of the substrate is not necessarily the gas atmosphere such as the vacuum, nitrogen, mixture gas of nitrogen and oxygen, or rare gas atmosphere, so that the production facility can be simplified. In addition, according to the production method in this embodiment, film 17 can be removed in the sealing and exhausting step for front plate 2 and rear plate 10. Therefore, it is not necessary to provide a step for removing film 17, so that the production facility can be simplified.

In addition, as shown in FIG. 3, while the film forming step is performed after the protective layer forming step in this embodiment, it may be performed after the base film vapor deposition step before the aggregated particle paste applying step in the protective layer forming step shown in FIG. 10. When the film forming step is performed after the base film vapor deposition step before the aggregated particle paste applying step, aggregated particles 92 can be attached on protective layer 9 with high adhesion. Therefore, the initial electron emission characteristics are enhanced, and the discharge delay is further reduced.

### 7. Summary

The method for producing PDP 1 according to this embodiment includes the following process. Here, PDP 1 according to this embodiment includes rear plate 10, and front plate 2 sealed with discharge space 16 provided, with rear plate 10. Front plate 2 has dielectric layer 8 and protective layer 9 to cover dielectric layer 8. Protective layer 9 includes base film 91 formed on dielectric layer 8. Aggregated particles 92 composed of aggregated crystal particles 92a of the magnesium oxide are dispersed all over base film 91. Base film 91 includes at least the first metal oxide and the second metal oxide. In addition, base film 91 has at least one peak through the X-ray diffraction analysis. The peak of base film 91 exists between the first peak of the first metal oxide through the X-ray diffraction analysis and the second peak of the second metal oxide through the X-ray diffraction analysis. The first peak and the second peak show the same surface orientation as the surface orientation shown by the peak of base film 91. The first metal oxide and the second metal oxide are composed of two kinds of metal oxides selected from the group of a magnesium oxide, a calcium oxide, a strontium oxide, and a barium oxide.

Thus, according to the method for producing PDP 1 in this embodiment, front plate 2 on which protective layer 9 has been formed is fired at the temperature in the range of 350° C. to 500° C. in the atmosphere containing at least one of the nitrogen gas, the mixture gas of nitrogen and oxygen, and the rare gas, and the water molecule. Then, film 17 of the water molecule or hydroxide is formed on the surface of protective layer 9 at the lowered temperature of 200° C. or less in the same atmosphere. Then, front plate 2 having film 17 and rear plate 10 are oppositely arranged. Then, film 17 is removed from protective layer 9, and the water molecule is exhausted from discharge space 16 by heating the opposed front plate 2 and rear plate 10. Then, front plate 2 from which film 17 has been removed, and rear plate 10 are sealed.

According to the method for producing PDP 1 in the other embodiment, front plate 2 on which base film 91 has been formed is fired at the temperature in the range of 350° C. to 500° C. in the atmosphere containing at least one of the nitrogen gas, the mixture gas of nitrogen and oxygen, and the rare gas, and the water molecule. Then, film 17 of the water molecule or hydroxide is formed on the surface of base film 91 at the lowered temperature of 200° C. or less in the same atmosphere. Then, front plate 2 having film 17 and rear plate 10 are oppositely arranged. Then, film 17 is removed from base film 91, and the water molecule is exhausted from discharge space 16 by heating the opposed front plate 2 and rear plate 10. Then, front plate 2 from which film 17 has been removed, and rear plate 10 are sealed.

According to the method for producing PDP 1 in this embodiment, base film 91 which provides both effects of low voltage drive and charge retention, and aggregated particle 92 of MgO which provides the effect of discharge delay prevention are formed through the above process, so that the high-definition PDP can be driven at high speed and at low voltage in PDP 1 as a whole, and high-quality image display performance is realized by preventing the lighting defect. In addition, since film 17 is formed on protective layer 9 or base film 91, base film 91 can be prevented from being deteriorated, and the sustain voltage can be reduced.

### INDUSTRIAL APPLICABILITY

As described above, the technique disclosed in this embodiment is useful for realizing the PDP which is provided with high-definition and high-brightness display performance, and keeps its power consumption low.

### REFERENCE MARKS IN THE DRAWING

1 PDP
2 front plate
3 front glass substrate
4 scan electrode
4a, 5a transparent electrode
4b, 5b bus electrode
5 sustain electrode
6 display electrode
7 black stripe
8 dielectric layer
9 protective layer
10 rear plate
11 rear glass substrate
12 data electrode
13 base dielectric layer
14 barrier rib
15 phosphor layer
16 discharge space
17 film
91 base film
92 aggregated particle
92a crystal particle

1. A method for producing a plasma display panel including a rear plate and a front plate with a discharge space sealed therebetween, wherein
the front plate has a dielectric layer and a protective layer that covers the dielectric layer,
the protective layer includes a base layer formed on the dielectric layer,
aggregated particles composed of aggregated crystal particles made of a magnesium oxide are dispersed all over the base layer,
the base layer contains at least a first metal oxide and a second metal oxide,
the base layer has at least one peak through an X-ray diffraction analysis,
the peak exists between a first peak of the first metal oxide through an X-ray diffraction analysis and a second peak of the second metal oxide through an X-ray diffraction analysis,
the first peak and the second peak show the same surface orientation as a surface orientation shown by the peak,
the first metal oxide and the second metal oxide are composed of two kinds of oxides selected from a group consisting of a magnesium oxide, a calcium oxide, a strontium oxide, and a barium oxide,
the method comprising:
firing the front plate having the protective layer at a temperature in a range of 350° C. to 500° C. in an atmosphere containing a water molecule and at least one selected from a group consisting of a nitrogen gas, a mixture gas of nitrogen and oxygen, and a rare gas; then
forming a film of a water molecule or hydroxide on a surface of the protective layer by lowering a temperature to 200° C. or less in the above atmosphere; next
oppositely arranging the front plate having the film thereon to the rear plate; then
removing the film from the protective layer, and exhausting the water molecule from the discharge space by heating the oppositely arranged front plate and rear plate; and then
sealing the front plate having no film and the rear plate together.

2. A method for producing a plasma display panel including a rear plate and a front plate with a discharge space sealed therebetween, wherein
the front plate has a dielectric layer and a protective layer that covers the dielectric layer,
the protective layer includes a base layer formed on the dielectric layer,
aggregated particles composed of aggregated crystal particles made of a magnesium oxide are dispersed all over the base layer,
the base layer contains at least a first metal oxide and a second metal oxide,
the base layer has at least one peak through an X-ray diffraction analysis,
the peak exists between a first peak of the first metal oxide through an X-ray diffraction analysis and a second peak of the second metal oxide through an X-ray diffraction analysis,
the first peak and the second peak show the same surface orientation as a surface orientation shown by the peak,
the first metal oxide and the second metal oxide are composed of two kinds of oxides selected from a group consisting of a magnesium oxide, a calcium oxide, a strontium oxide, and a barium oxide,
the method comprising:
firing the front plate having the base layer at a temperature in range of 350° C. to 500° C. in an atmosphere containing a water molecule and at least one selected from a group consisting of a nitrogen gas, a mixture gas of nitrogen and oxygen, and a rare gas; then
forming a film of a water molecule or hydroxide on a surface of the base layer by lowering a temperature to 200° C. or less in the above atmosphere; next
dispersing the aggregated particles on the surface of the base layer having the film; then
oppositely arranging the front plate having the film and the aggregated particles thereon to the rear plate; next
removing the film from the base film, and exhausting the water molecule from the discharge space by heating the oppositely arranged front plate and rear plate; and then
sealing the front plate having no film and the rear plate together.
